(19) United States
(12) Patent Application Publication
(10) Pub. No.: US 2009/0295671 A1
(43) Pub. Date: Dec. 3, 2009

(54) Method of Producing Communication Circuit, Communication Device, an Impedance- Matching Circuit, and an Impedance-Matching Circuit, and an Impedance-Matching Circuit Design Method

(76) Inventors: Keiji Yoshida, Fukuoka (JP); Haruichi Kanaya, Fukuoka (JP)

Correspondence Address: STAAS & HALSEY LLP, SUITE 700, 1201 NEW YORK AVENUE, N.W., WASHINGTON, DC, 20005, US

(21) Appl. No.: 11/886,640

(22) PCT Filed: Mar. 3, 2006
(86) PCT No.: PCT/JP2006/304154

§ 371 Date: May 21, 2009

(30) Foreign Application Priority Data
Mar. 18, 2005 (JP) 2005-080671

(51) Int. Cl. H01Q 1/50

(52) U.S. Cl. 343/860

(57) ABSTRACT

Communication circuit 1 is provided with antenna sections 3, such as a nonresonant antenna, and matching section 5 which connects with antenna section 3 and adjusts impedance, for example.

Matching section 5 has a transmission line and the electric length and characteristic impedance of a transmission line are determined based on the frequency or the frequency band in which antenna section 3 and a transmission line resonate.

For example, since it is not necessary to unite resonance frequency with center frequency if it is a nonresonant antenna, it becomes possible to attain the miniaturization of an antenna.

Wide band-ization is realizable by changing the characteristic impedance of a transmission line.

### FIELD OF THE INVENTION

This invention relates to a method of producing communication circuit, a communication device, an impedance-matching circuit, and an impedance-matching circuit and an impedance-matching circuit design method, especially it relates to a communication circuit having a transmission line with an impedance-matching circuit.

### BACKGROUND OF THE INVENTION

In an information-oriented society in recent years, the system using radio, such as mobile communications and satellite communications, has spread quickly.
In connection with it, the miniaturization is demanded of communications systems with highly-efficient-izing and efficient-ization.
It depends for the size of communications systems on the size of an antenna greatly.
Therefore, in order to miniaturize communications systems, it becomes important to miniaturize an antenna, without making performance low.

As compared with the wavelength of the radio signal used in communications systems, a sufficiently small antenna is called a minute antenna.
Various design methods are proposed about such a minute antenna (for example, refer to patent documents 1, patent documents 2, and nonpatent literature 1).
[Patent documents 1]
JP,2004-274513,A
[Patent documents 2]
JP,2003-283211,A
[Nonpatent literature 1]
   Yoko Koga, outside 3 excellent book, “the design evaluation of a superconductivity slot array antenna with a filter”, the Institute of Electronics, Information and Communication Engineers technical research report (S C E2002-5, MW2002-5), 2002, p. 23-28

### DESCRIPTION OF THE INVENTION

### Problem(s) to be Solved by the Invention

The conventional antenna is a resonance type.
The antenna needed to unite resonance frequency with center frequency. Therefore, the size is determined by the frequency of resonance and it is difficult to design a size freely.
Such a subject is the same also about general loads other than an antenna.

Then, the purpose of this invention is to offer the communication circuit, the communication device, impedance-matching circuit, and impedance-matching circuit design method which suit the miniaturization of an antenna etc.

### Means for Solving the Problem

An invention concerning claim 1 is the communication circuit provided with an impedance-matching circuit linked to a dissonance type antenna and said dissonance type antenna.
Said impedance-matching circuit has a transmission line which an end connects to said nonresonant antenna.
The electric length and characteristic impedance of said transmission line are determined by the predetermined approximate expression based on the frequency or the frequency band in which said nonresonant antenna and said transmission line resonate.

It may be the communication circuit according to claim 1, and said dissonance type antenna may be in-series dissonance or parallel dissonance.
In that case, the electric length and characteristic impedance of said transmission line may be determined based on the internal impedance of this antenna, when said antenna is in-series dissonance.
Or the electric length and characteristic impedance of a transmission line may be determined based on the internal admittance of this antenna, when said antenna is parallel dissonance.

It is the communication circuit according to claim 1, and said impedance-matching circuit may have an inverter.
Consistency can be taken by devising shape of an inverter and changing a parameter by such composition, also when a rate of impedance conversion is very large.

It may be the communication circuit according to claim 1, and said transmission line may be a distributed constant line constituted by dielectric substrate like for example, a co-planer waveguide way.

It may be the communication circuit according to claim 1, and a transmission line may be meander shape.
While the transmission line has been a straight line, a transmission line is bent, and such composition enables it to attain the miniaturization of the whole length.
When it is possible to establish a transmission line in an inside of an antenna like [in case an antenna is parallel dissonance, for example], it becomes possible to constitute the whole circuit from a size of an antenna substantially.

It is the communication circuit according to claim 1, and may realize using a high temperature superconductor.
By using high temperature superconducting to conductive line in an antenna, which shows a very low conductive loss, that may be a cause of decreasing of efficiency.
By the reason, the efficiency of the conductive loss that cause a decline of efficiency.

The communication circuit according to claim 1 may be a transmitting circuit, a receiving circuit, or a transceiver circuit.

The invention concerning claim 2 is the communication circuit provided with the impedance-matching circuit linked to a nonresonant antenna and said nonresonant antenna.
Said impedance-matching circuit has a transmission line, and electric length theta 0 and characteristic impedance Z1 of said transmission line can be culcurate from Qe1 of external Q, reactance Xa of nonresonant antenna and radiation resintance Ra, using formura (eq1).

An invention concerning claim 3 is the communication circuit provided with an impedance-matching circuit linked to a dissonance type antenna and said dissonance type antenna.
Said impedance-matching circuit has a transmission line, and electric length theta 0 and characteristics inductance Y1 of said transmission line are calcurated using Qe1 of external Q, susceptance Ba of said nonresonant antenna and conductance Ga by formura (eq2).

### [Equation 1]

The invention concerning claim 4 is the communication circuit according to claim 2 or 3, said impedance-matching circuit having an electric power matching means for adjusts electric power of said nonresonant antenna and the external circuit, and electric power of said transmission line.

The invention concerning claim 5 is the communication circuit according to claim 4, and said electric power matching means is an inverter. As for J parameter of said inverter, said nonresonant antenna and said transmission line reach characteristic impedance Z0, and conductance Gin receives, and it is culcurated by the formula (eq3).

### [Equation 2]

The invention concerning claim 6 is the method of producing the impedance-matching circuit linked to a dissonance type antenna. Said impedance-matching circuit has a transmission line which an end connects to said nonresonant antenna.
The electric length and characteristic impedance of said transmission line contain the step determined by the predetermined approximate expression based on the frequency or the frequency band in which said nonresonant antenna and said transmission line resonate.

The invention concerning claim 7 is an impedance-matching circuit linked to a nonresonant antenna.
An impedance-matching circuit has a transmission line and the electric length and characteristic impedance of said transmission line are determined by the predetermined approximate expression based on a joint relation with the circuit except said nonresonant antenna.

The invention concerning claim 8 is a communication device provided with two or more impedance-matching circuits according to claim 7.

It is distinguished so that the frequency band of at least two impedance-matching circuits where center frequency adjoins each other among said plural impedance-matching circuits may not overlap mutually. Plural impedance-matching circuits can input the signal of mutually different frequency into said matching circuit.

The output possibility of or an input/output is possible for the signal of different frequency from said matching circuit.
The signal of different frequency overlaps, is set as a wide area, and the input possibility of or said matching circuit to an output is possible for it to said matching circuit.

The invention concerning claim 9 is a designing method of an impedance-matching circuit linked to a nonresonant antenna.
This designing method contains the step which determines the circuit pattern of an impedance-matching circuit by a predetermined approximate expression based on a joint relation with an external circuit.
It may be the recording medium which recorded the program which makes a computer perform the impedance-matching circuit design method according to claim 9, or said program and in which computer reading is possible.

### Effect of the Invention

According to the invention in this application, it becomes possible to combine an impedance-matching circuit with a dissonance type antenna etc., and to design as a resonator.
For example, if it is a nonresonant antenna, it is not necessary to unite resonance frequency with center frequency.
Therefore, the miniaturization of an antenna can be attained and it becomes possible to attain the further miniaturization of the whole communications systems.
Wide band-ization is realizable by changing the characteristic impedance of a transmission line.

Performance prediction was performed by the electromagnetic field simulator about the thing which made the slotted dipole antenna and the matching circuit unify on a high-temperature superconductivity thin film substrate.
This antenna has a length of 3100 [mum]×1900 [mum], including a matching circuit.
This antenna can be miniaturized very much for wavelength lambda (about 26000 [mum]).
It is 3070 [mum]×600 [mum] only by the antenna section.
The typical half wavelength rectangle patch antenna of the antenna used for wireless LAN is abbreviation 13000 [mum]×13000 [mum] in the same center frequency and a base dielectric constant.
Therefore, as compared with the antenna which has spread now, area is about 1/91, and the obtained antenna can be said for a remarkable miniaturization to be realizable.

### BRIEF DESCRIPTION OF THE DRAWINGS

### [Drawing 1]

It is a schematic block diagram of communication circuit 1 concerning an embodiment of the invention.

### [Drawing 2]

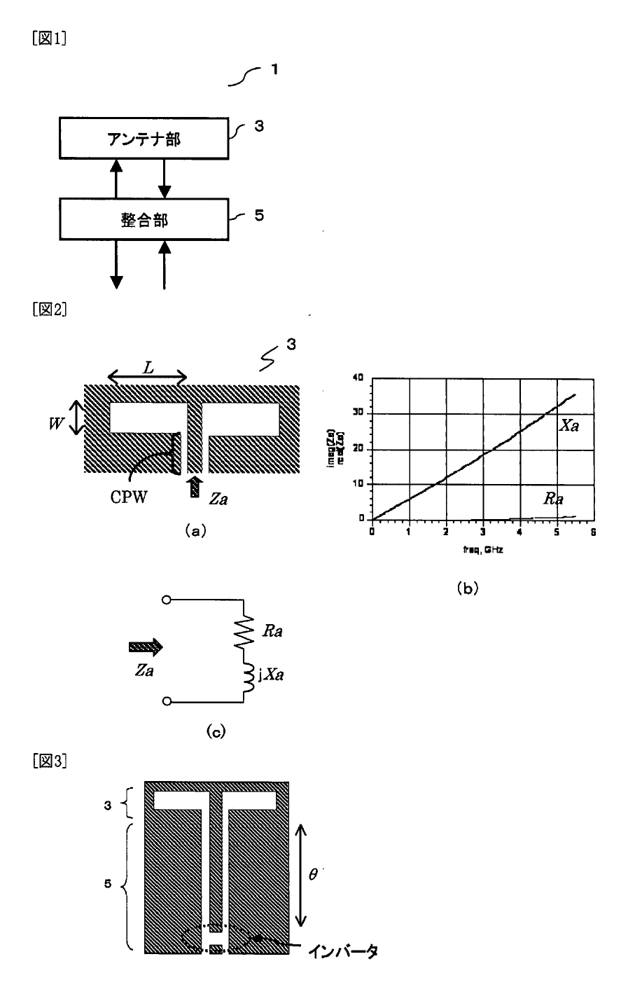

It is a figure showing the antenna which is an example of antenna section 3 of FIG. 1.

### [Drawing 3]

It is a figure showing the matching circuit which is an example of matching section 5 of FIG. 1.

### [Drawing 4]

It is a figure showing the concept of distributed constant line.

### [Drawing 5]

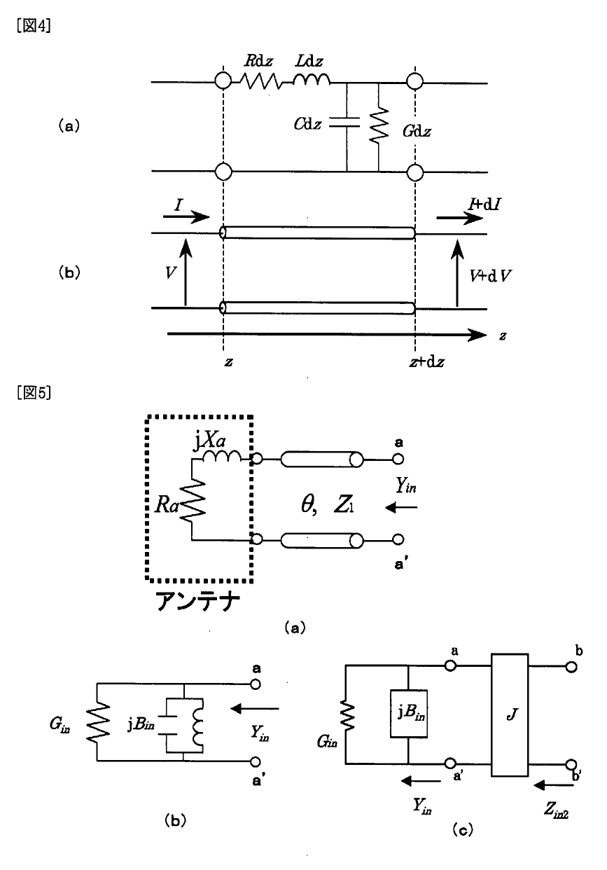

It is a figure showing an antenna equal circuit with a matching circuit provided with the antenna of FIG. 2, and matching section 5 of FIG. 3.

### [Drawing 6]

It is a figure showing the composition of prototype 1 stage filter.

### [Drawing 7]

It is a figure showing the wave which function Sinc (theta) draws.

### [Drawing 8]

It is a figure showing the shape of ƒRƒvƒCE [ƒi waveguide way (CPW).

### [Drawing 9]

It is a figure showing change of characteristic impedance Z1 in the case of using the base of another thickness.

### [Drawing 10]

It is a figure showing the simulation result of radiation resistance Ra when changing antenna width W noting that characteristic impedance Z1 of antenna length L and CPW is constant.

### [Drawing 11]

It is a figure showing the simulation result of the value of external Q when changing antenna width W noting that characteristic impedance Z1 of antenna length L and CPW is constant.

### [Drawing 12]

It is a comparison figure of antenna size.

### [Drawing 13]

It is a figure showing the designed minute slot antenna with a matching circuit.

### [Drawing 14]

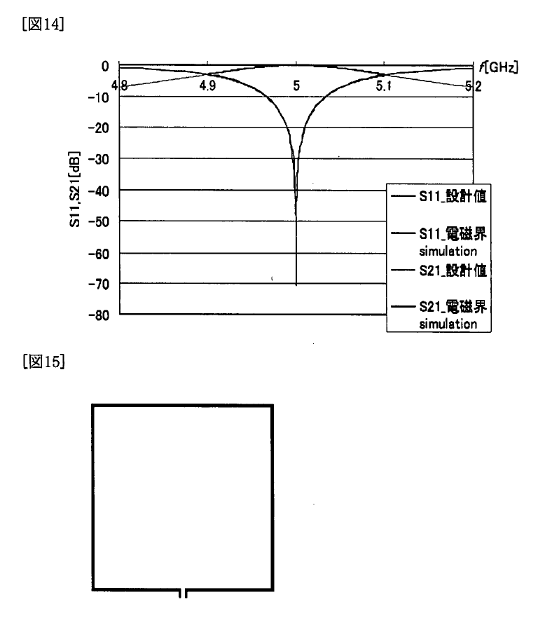

It is a figure showing the analysis output by the simulation of the reflection coefficient of the antenna of FIG. 13, and a transmission coefficient.

### [Drawing 15]

It is a figure showing other examples of the antenna section of FIG. 1.

### [Drawing 16]

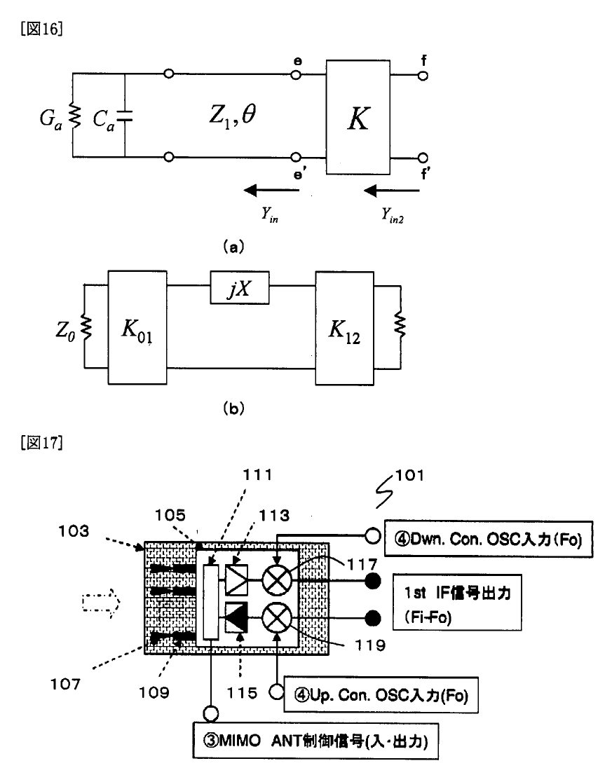

It is a figure showing the antenna equal circuit with a matching circuit of FIG. 15, and the circuit based on filter theory.

### [Drawing 17]

It is a figure showing one embodiment of the application to MIMO communication Technology.

### [Drawing 18]

It is a figure showing one embodiment of the application to UWB method communication.

### [Drawing 19]

It is a figure showing an example of the simultaneous transmissive communication in a wave number two or more rounds.

### [Drawing 20]

It is a circuit diagram showing the state of connecting each of three steps of band pass filter integral-type ƒRƒvƒCE [ƒi waveguide way (CPW) matching circuits to each of three antennas, and making three channels corresponding.

### [Drawing 21]

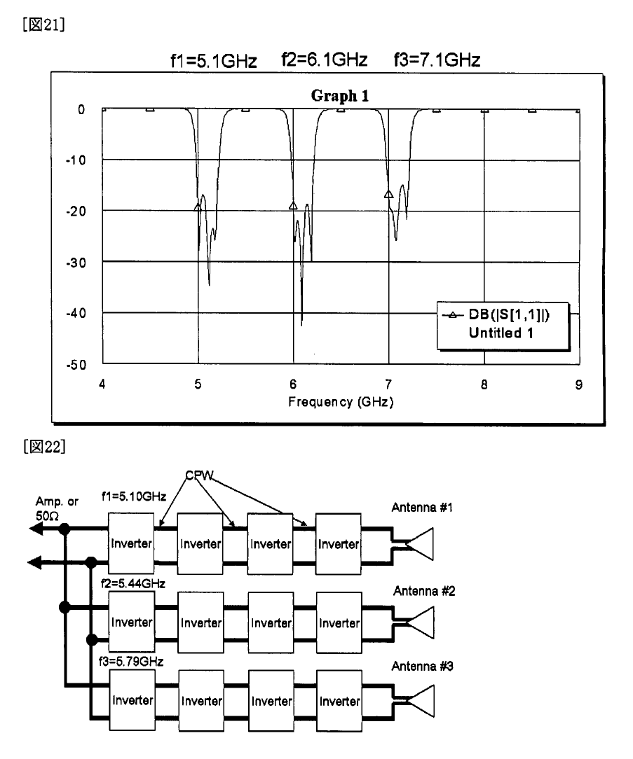

It is a figure showing the result of having performed the simulation based on the circuit diagram of FIG. 20.

### [Drawing 22]

It is a circuit diagram showing the state where connected each of three steps of band pass filter integral-type ƒRƒvƒCE [ƒi waveguide way (CPW) matching circuits to each of three antennas, and broadening of 5 GHz bands was attained.

### [Drawing 23]

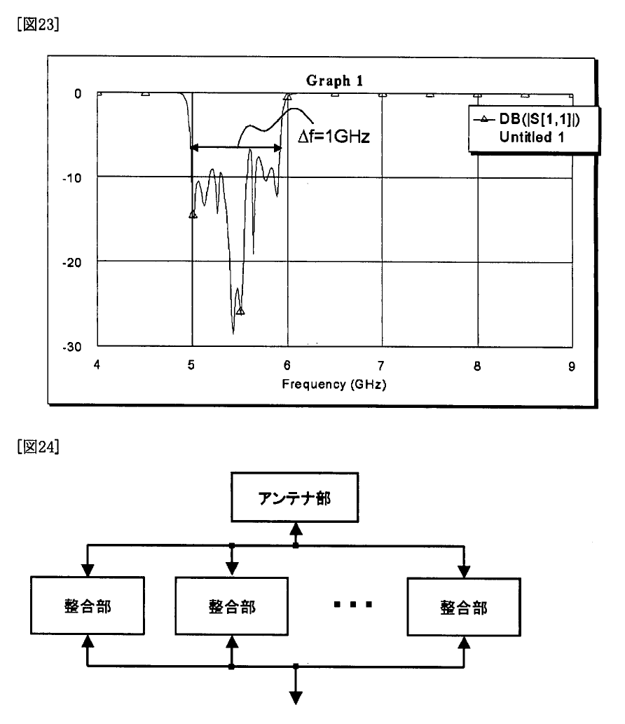

It is a figure showing the result of having performed the simulation based on the circuit diagram of FIG. 22.

### [Drawing 24]

It is a figure showing other examples of a circuit provided with plural matching circuits.

### DESCRIPTION OF NOTATIONS

1 Communication Circuit
3 Antenna Section
5 Matching Section

### BEST MODE OF CARRYING OUT THE INVENTION

FIG. 1 is a schematic block diagram of communication circuit 1 concerning an embodiment of the invention.
Communication circuit 1 is provided with antenna section 3 and matching section 5 linked to said antenna section 3.
Said matching section 5 adjusts impedance.

FIG. 2(a) is a figure showing the minute slotted dipole antenna which is an example of antenna section 3 of FIG. 1.
The antenna is connected to matching section 5 by the co-planer waveguide way (CPW) in this example.
In FIG. 2(a), antenna length L [mum] is L<<lambda to guide wavelength lambda [mum].
If the antenna of FIG. 2(a) is analyzed by an electromagnetic field simulation, the frequency characteristic of the impedance Za will become as it is shown in FIG. 2(b).
Inclination of radiation resistance Ra and reactance Xa becomes fixed near center frequency (for example, 5.0 GHz).
Therefore, the equal circuit of this antenna can be expressed with the series circuit of radiation resistance Ra and reactance Xa as shown in FIG. 2(c).
The point is a short-shaped thing and this antenna is called in-series dissonance.

FIG. 3 is a figure showing the matching circuit which is an example of matching section 5 of FIG. 1.
In FIG. 3, a matching circuit has a transmission course and an inverter. Transmission courses are two parallel signal lines, electric length is theta, as for these signal lines, an end is connected with antenna section 3, and another side is connected outside via an inverter.

In this example, matching section 5 of FIG. 1 is designed using characteristic impedance Z1 and electric length theta 0 of a transmission line who are called for based on the design formula of a formula (1).

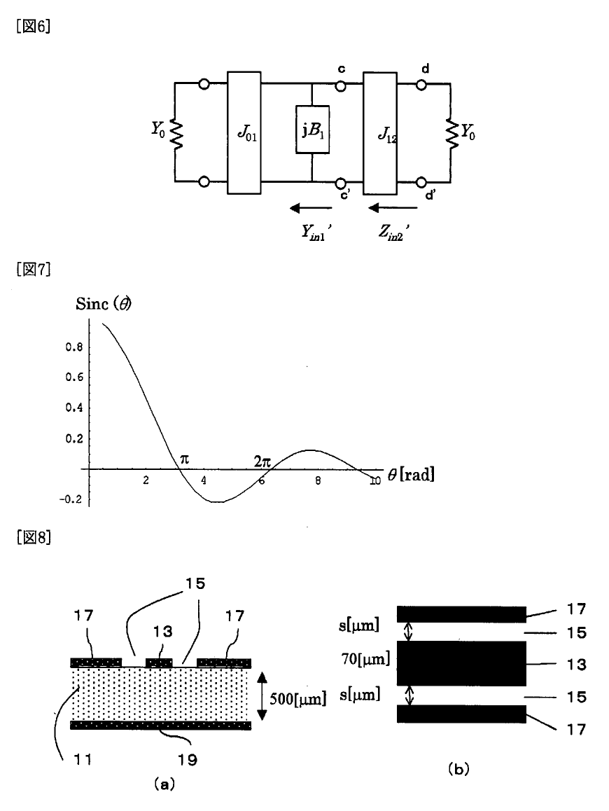

In a formula (1), Qe1 is external Q (coupling amount with an external circuit) of a resonator (refer to formula (53)).
Function Sinc (theta) is Sinc(theta)=sin theta/theta (refer to FIG. 7).
The design formula of this formula (1) is drawn based on the conditions which become equivalent [an antenna equal circuit with a matching circuit (refer to FIG. 5(c)), and the circuit (refer to FIG. 6) based on filter theory], although mentioned later for details.

### Equation 3

The design formula of a formula (1) is explained focusing on the derivation using FIGS. 4-7.

First, a band-pass filter is explained.
A filter is a device which passes the signal of a certain required frequency band, and intercepts the signal of an unnecessary frequency band.
There is a Chebyshev filter in a common band-pass filter, for example. Below, a design formula is described about a Chebyshev filter.
For example, it can ask for a design formula similarly about filters other than a Chebyshev filter, such as the maximum flat filter.

If the relative bend of desired band-pass filter is w, and center frequency is omega 0, the relative band w and center frequency omega 0 can be explained in formura (2).
Here, omega1 and omega2 are interception angular frequency.

### Equation 4

The band-pass filter has a LC series resonance device and LC parallel circuit.
(For example, G. L. Matthaei work, “Microwave Filters, Impendence-matching Networks, and Coupling Structures”, Artech House, 1980, p. 429 reference).
Lk and Ck of LC series resonance device are expressed like a formula (3), and Lj and Cj of LC parallel resonance device are expressed like a formula (4).
Here, gi is a standardization device value, and when the reflection coefficient in the point that the ripple of a pass band serves as the maximum is set to RLr, it is expressed like a formula (5).
beta, gamma, ak, and bk are expressed like a formula (6) and a formula (7).

### Equation 5

In a one terminal pair network versus a network, a reflection coefficient and a transmission coefficient are used as a parameter which evaluates propagation of electric power and a signal wave.
These are called for like a formula (8) from an S matrix.
Here, they are S11=(reflection electric power)/(input power) and S21=(penetration electric power)/(input power).

### Equation 6

In the case of a receiving antenna, evaluation of performance is usually performed with a transmission coefficient.
To evalutate the antenna performance, a conductor loss can be disregarded in following case.

|S11|2+|S21|2=1
Since the above-mentioned formula is realized, the design of a transmission coefficient can be performed simultaneously with the reflection coefficient which is the characteristics of a matching circuit.
About the gain which is the characteristics of an antenna, transmitting gain and receiving gain are equivalent.
By the below-mentioned electromagnetic field simulator, analysis of a reflection coefficient is conducted from the character.
Therefore, below, suppose that evaluation of performance is performed with a reflection coefficient.

Then, the slope parameter showing the characteristics of resonance devices, such as a series resonance device and a parallel resonance device, is explained.
First, about a series resonance device, if the reactance of a series resonance device is set to Xk, reactance slope parameter xk will be defined by the formula (9).
Reactance Xk and resonance frequency omega0 of a series resonance device is shown in a formula (10).
Therefore, reactance slope parameter xk is expressed like a formula (11).
Reactance Xk of a series resonance device is expressed like a formula (12) from this.

### Equation 7

Susceptance slope parameter bj is similarly defined as susceptance being Bj by a formula (13) about a parallel resonance device.
Susceptance [of a parallel resonance device] Bj and resonance frequency omega0 is shown in a formula (14).
Therefore, susceptance slope parameter bj is expressed like a formula (15).
Susceptance Bj of a parallel resonance device is expressed like a formula (16) from this.

### Equation 8

Then, the composition of the filter by an inverter is explained. Inverters include J inverter and K inverter and the shadow phase quantity of each of these is } pi/2 or its device which shifts odd times in an input edge and an outgoing end.
Therefore, seen from the input edge of an inverter, load impedance is visible as if it was reversed.
The concatenation procession (procession which determines the output voltage and output current when deciding the input voltage and the input current of a circuit) of an inverter is expressed like [definition/the ] a formula (17).
Here, K and J under procession are called K parameter and J parameter, respectively, and the relation K=1/J is realized.

### Equation 9

Then, a circuit provided with a parallel resonance device and J inverter is examined.
The circuit which the parallel resonance device of susceptance B′ connects with the exterior via J inverter is considered.
Since a concatenation procession is expressed like a formula (18), this circuit will become equivalent to the series resonance device of reactance X, if B′ is set to B′=J2X.
Therefore, the series resonance device is equivalent to a circuit provided with a parallel resonance device and J inverter.
Therefore, n stage band-pass filter can consist of only a parallel resonance device and a J inverter.
Susceptance Bi and J parameter of a parallel resonance machine at this time are given by the formula (19) and a formula (20), respectively.

### Equation 10

Then, a distributed constant line is explained with reference to FIG. 4.
It becomes impossible for the size of a circuit to ignore compared with a wavelength in high frequency.
Therefore, it comes to be hard of realizing a circuit with concentrated constant devices, such as capacitance and a reactance.
Then, current and voltage are considered to be the functions of time and a position, and transmission circuitry approximates with that from which the minute circuit element was distributed over those propagation.
This approximation circuit is called a distributed constant line.

FIG. 4(a) and FIG. 4(b) serve as an equal circuit about minute sections dz on a track.
If the differential equation about the current and voltage of this circuit is expressed like an equation (21) and this is solved, the result of an equation (22) will be obtained.
However, K1 and K2 are arbitrary constants, gamma and Z0 are called a propagation constant and characteristic impedance, respectively, and it is expressed like a formula (23).

Real part alpha is called an attenuation coefficient, and imaginary part beta is called a phase constant when indicating the plural of propagation constant gamma.

Since R<<omegaL and G<<omegaC are realized in a general transmission line, alpha and beta can be expressed like a formula (24).

### Equation 11

Then, the concatenation procession showing the transmission line of length 1 is considered.
If V (0)=V1 and I(0)=I1, the boundary condition of a formula (25) will be acquired from a formula (22).
A formula (27) is drawn by substituting this boundary condition for a formula (22), and using the relation of a formula (26).
Therefore, voltage V2 and current I2 in z=1 are expressed like a formula (28).
If a formula (28) is expressed using an inverse matrix, length 1 and the concatenation procession of the transmission line of characteristic impedance Z0 will be obtained like a formula (29).
At the time of alpha<<1, supposing the electric length corresponding to length 1 is theta, a formula (29) is expressed with a formula (30) from gamma 1=jbeta1=j theta.

### Equation 12

The above filter theory is applied and the design theory of matching section 5 of FIG. 1 is derived.
When an antenna is in-series dissonance, an antenna is expressed with the series circuit of radiation resistance Ra and reactance Xa as shown in FIG. 2(c).
If this impedance is set to Za,
It is Za=Ra+jXa=Ra+jomegaL.

FIG. 5(a) is a figure in which load impedance Za shows the circuit connected to the unlost transmission line of electric length theta and characteristic impedance Z1.
From a formula (30), input impedance Zin seen from terminal a-a′ is expressed with a formula (31).

FIG. 5(b) is a figure showing the parallel resonant circuit of center frequency omega0 which can be regarded as the circuit of FIG. 5(a) being equivalent, when a transmission line is made into suitable length (referred to as theta 0 below).
Input admittance Yin (Yin=1/Zin) of this parallel resonant circuit is expressed like a formula (32) (refer to formula (16)).
Here, susceptance slope parameter b is expressed with a formula (33) (refer to formula (13)).

FIG. 5(c) is a figure in which the circuit of FIG. 5(b) shows the circuit connected with the exterior via J inverter.
Input impedance Zin2 of the circuit of FIG. 5(c) becomes like a formula (34).

### Equation 13

On the other hand, prototype 1 stage filter comprised as shown in FIG. 6, from a formula (19) and a formula (20), and the designed value is given as a formula (35).
Here, “w” shows a relative band, “b” shows a susceptance slope parameter and “gi” shows a standardization device value.
In FIG. 6, as Yin1′ shown in formura (36) when looking at left side from terminal c-c′, the impedance Zin2′ shown in formura (37) when looking at left side from terminal d-d′.

### Equation 14

By determining external Q of parallel resonance and J parameter of J inverter, so as to Zin2=Zin2′ in formura (34) and formura (37), the matching circuit of FIG. 5(c) can be same as a filter of FIG. 6. Therefore, a designed value is given by the formula (38) and a formula (39).

### Equation 15

Then, the circuit of FIG. 5(a) becomes equivalent to a parallel resonance device, and the external Q leads characteristic impedance Z1 and electric length theta 0 of the transmission line, as satisfy formura (38).
In a formula (31), a definition of z, r, and x which fill a formula (40) will express input admittance Yin of the circuit of FIG. 5(a) like a formula (41).

### Equation 16

Since the susceptance of a parallel resonance device becomes zero in center frequency, theta 0 should just be taken as the electric length that an imaginary part is set to 0 in a formula (41).
Therefore, theta 0 fills a formula (42).

### Equation 17

Here, when the numerator of a formula (41) is set with h (theta) and a denominator is set with H (theta), h (theta) and H (theta) are expressed like a formula (43) and a formula (44) using a formula (42), respectively.

### Equation 18

Therefore, conductance Gin of center frequency omega0 becomes like a formula (45).
However, x0 is a value of x in center frequency, and is x0=omega0La/Z1. Susceptance Bin is expressed like a formula (46).

### Equation 19

In a formula (46), since frequency dependence is produced from a formula (47), susceptance slope parameter b is given by a formula (48). When d/dx(tan−1x)=1/(1+x2) is used, susceptance slope parameter b is expressed like a formula (49) from a formula (48).

### Equation 20

About conductance Gin, if it is considered as a formula (50), external Q of a resonator will be called for from a formula (45) and a formula (49).
Since this external Q fills a formula (38), a formula (51) is realized.

### Equation 21

By allying a formula (51) and a formula (42), the design formula of Z1 and theta0 is obtained.
Here, since r=Ra/Z1<<1 and x are realized with a minute antenna, a formula (42) and a formula (51) can be approximated like a formula (52) and a formula (53), respectively.
A formula (54) is obtained from a formula (52).
If a formula (40) is used for a formula (53) and a formula (54), a formula (55) and a formula (56) will be obtained.
Here, Xa is taken as the value in center frequency.

### Equation 22

A formula (56) is expressed like a formula (57), when a formula (54) is substituted and arranged, and when function Sinc(theta)=sin theta/theta is introduced, it is expressed like a formula (58). However, since function Sinc (theta) draws a wave as shown in FIG. 7, in order for theta 0 which fills a formula (58) to exist in 0<theta0<theta/2, it must fill Qe1>Xa/2Ra.

### Equation 23

As mentioned above, the design formula of a matching circuit is given by the formula (55) and a formula (58).

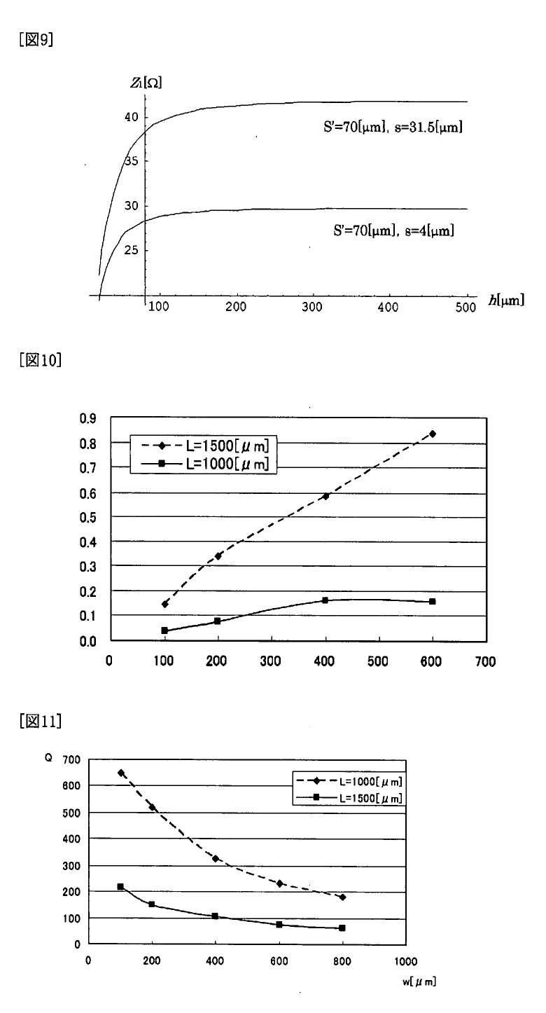

Then, it explains realizing a matching circuit by a co-planer waveguide way.
FIG. 8 is a figure showing an example of the shape of a co-planer waveguide way (CPW).
In FIG. 8, two slots are formed in parallel to the wrap conductor in the field where CPW has dielectrics.
The conductor between two slots is called a central conductor.
As for CPW, characteristic impedance is decided by the width of a central conductor, and the gap between conductors.
Therefore, line width can be narrowed if needed and it is effective in the miniaturization of a circuit.

If the thickness of an electrode is assumed to be the infinitesimal, effective dielectric constant epsiloneff and characteristic impedance Z0 will be given by a formula (59).
When a substrate has limited thick h, effective dielectric constant epsiloneff and characteristic impedance Z0 are expressed with a formula (60).
However, it is k1=a/b and is k2=sinh(pia/2h)/sinh (pib/2h).
epsilonr is the specific inductive capacity of a substrate and K is approximated by a formula (61) by the first-sort complete elliptic integral.

### Equation 24

Then, the composition of J inverter using a co-planer waveguide way is explained.
If the gap of the suitable length for the central conductor of a co-planer waveguide way is provided, an adjoining central conductor will have capacity and the effect as in-series capacitance will be acquired. Capacity exists also between the gap portion of a central conductor, and a ground, the work as parallel capacitance is also considered, and the gap portion of a co-planer waveguide way is considered to be pi form circuit of capacitance.
If the transmission line of the both ends of a gap is set to electric length phi/2, a concatenation procession also including a transmission line will become like a formula (62).
However, a transmission line is carried out [not having lost and] and characteristics admittance is set to Y0.

### Equation 25

In a formula (62), this circuit becomes equivalent to J inverter at the time of A=D=0 and C/B=J2 (for example, K C. Gupta, outside 3 excellent book, “Microstrip Lines and Slotlines”, Artechhouse, 1996, p. 444 reference).
A formula (63) and a formula (64) are realized at this time.
A formula (63) shows that actual phi/2 becomes negative length.
As mentioned above, J inverter is realizable with the gap provided in CPW, and CPW of electric length phi/2 of the both ends.

### Equation 26

An inverter is realizable on the gap provided in the transmission line, and the track of electric length phi/2 of the both ends.
About the inverter of the first rank, phi/2 track by the side of an input cannot be realized, but it becomes L type inverter.
This L type inverter serves as a circuit which resistance connects with the exterior via an inverter.
If input admittance Y of this L type inverter sets internal admittance to Y0 and the parameter of an inverter is set to J, it will become like a formula (65).
Internal admittance is set to Y0 and internal admittance Y0 has a circuit of susceptance Bb′ in series.
If there is a circuit which has susceptance Ba′ in parallel with these circuits, input admittance Y′ of this circuit will become like a formula (66).

A formula (67) will be obtained in a formula (65) and a formula (66) if Y=Y′.

### Equation 27

Here, when J parameter of L type inverter is made into Bb′, this J parameter is expressed like a formula (68).

### Equation 28

Then, the design of the minute-with matching circuit antenna using an electromagnetic field simulator is explained.
The electromagnetic field simulator used for the design calculates the S parameter of general plane circuits, such as a micro stripe, a slot line, a stripline, and the Copley ƒiƒ\check{∞}ƒCƒ″, based on a method of moment. 5.0 GHz and Mesh Frequency are 7.5 GHz, and, as for this setup, the number of cells of center frequency per wave is 30.

By formura (38), it is recoginized to get a bigger ratio of a band, in an impedance-matching circuit, it is required for the value of external Q of a resonance part.
It is thought that the value of external Q can be lowered by lowering the value of impedance Z1.
In order to enlarge radiation resistance, it is necessary to also take the shape of an antenna section into consideration.

First, CPW is analyzed.
FIG. 8 is a figure showing the shape of CPW used this time.
FIG. 8(a) is a figure showing the structure of a section, and FIG. 8(b) is a figure showing an upside structure.
With reference to FIG. 8(a), slot 15 is formed in central conductor 13 and its both sides, and CPW is created by the upper part of dielectrics 11.
Other portions 17 of the upper part of dielectrics and lower part 19 of dielectrics are grounds.
Here, dielectrics 11 are MgO (specific inductive capacity is 9.6), and thickness presupposes that it is 500 [mum].
With reference to FIG. 8(b), the width of central conductor 11 is 70 [mum], and width of slot 13 is set to s [mum].
To central conductor width, since the substrate is thick enough, characteristic impedance Z1 hardly changes to the case where there is no ground of a substrate rear.
Therefore, also theoretically, characteristic impedance can ask from a formula (61).
However, in order to acquire a more exact value, Z1 is analyzed by an electromagnetic field simulation.
The S matrix obtained from the simulation is changed into concatenation procession K, and Z1 is calculated like a formula (69) from the [1, 1] component and [1, 2] component.

### Equation 29

Next, the method of computing phase constant beta by an electromagnetic field simulation is explained.
Since the S matrix of the unlost transmission line of length 1 can be expressed as a formula (70), it asks like a formula (71) from [2, 1] component of the S matrix obtained from the simulation.

### Equation 30

In order to lower the value of external Q, it is thought that small CPW of characteristic impedance is desirable.
FIG. 9 is a figure which is called for from a formula (60) and in which showing change of characteristic impedance Z1 in the case of using the substrate of another thickness.
When the ratio of substrate thickness to central conductor width h/Z1 is more than two, characteristic impedance does not affected by a back conductor and keep constant.
When the ratio h/Z1 is smaller than 1, characteristic impedance goes small as substrate thickness becomes thin.

Then, a minute slot antenna is analyzed.
The minute slotted dipole antenna of FIG. 2(a) was used as an antenna section this time.
As shown in FIG. 2(b), inclination of radiation resistance Ra and reactance Xa of this antenna becomes fixed near center frequency. Therefore, as shown in FIG. 2(c), it can express with the series circuit of radiation resistance Ra and reactance Xa, and the equal circuit of an antenna section can use the aforementioned consistency theory.

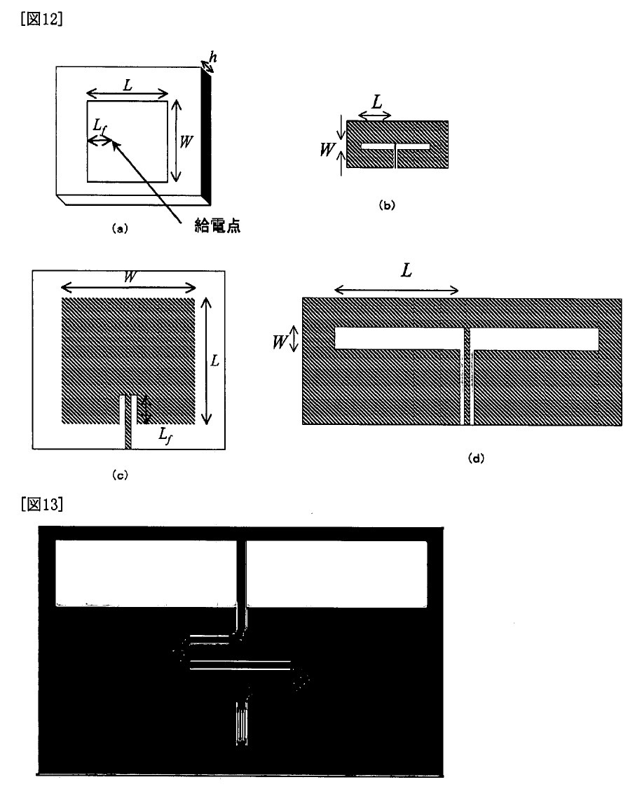

There is a limit in the value of the characteristic impedance of CPW. therefore, in order to enlarge a ratio band w, it is necessary to raise radiation resistance Ra of an antenna to some extent.
FIG. 10 is a figure showing the simulation result of radiation resistance Ra when seting antenna length L constant at 1000 [mum] or 1500 [mum], setting characteristic impedance Z1 of CPW to 50 [omega], and changing antenna width W.
A horizontal axis expresses antenna width and a vertical axis shows radiation resistance.
If antenna width spreads as shown in FIG. 10, radiation resistance will also increase.

Then, the design method of J inverter is explained.
As mentioned above, J inverter can consist of CPW(s) of electric length phi/2 of the gap provided in the signal line, and right and left. The shape of a gap has two kinds, a simple gap and an interdigital gap, according to the value of J parameter to realize.
Since big J parameter was needed, it designed this time using the interdigital gap.
The equal circuit of J inverter using an interdigital gap differs from the case of a simple gap.
The equal circuit has an ambiguous boundary of the discontinuous part of a transmission line, and a pure transmission line.
Therefore, susceptance Ba and pi type circuit of Bb concentrate on the center line of a gap, and it is thought that the transmission line of electric length phi/2 added to the right and left.

Since phi/2 is negative electric length, J inverter is designed by the following methods.
When considering the circuit which attached the transmission line of characteristic impedance Z1 and electric length theta to the both ends of an inverter theta is abbreviation pi/2 in weak combination (J/Y1<<1), the concatenation procession between the both ends of this circuit serves as a formula (72).
When it sets with −Z1sin theta=X here, a concatenation procession can be expressed as a formula (73).
It is set to X=0 when there is no gap in a resonance point and center frequency.
Therefore, the S matrix obtained by the simulation is changed into a concatenation procession.
If the line length of the both ends of a gap is adjusted so that the [1, 1], and [2, 2] component may be set to 0, the design of J inverter can be performed.
J parameter is obtained from [2, 1] component at this time.

### Equation 31

Then, the design of a minute-with matching circuit antenna is explained. First, the analysis of external Q of a resonator is explained.

Parallel resonance is obtained by adjusting the length of the transmission line tied to the antenna.
A band design is performed by adjusting so that external Q of this resonator may fill a formula (38).

External Q becomes like a formula (51) in the theoretical value by a circuit model.
When an antenna is small, the value of Ra obtained from the analysis of the antenna section is unreliable.
Therefore, it is thought that a gap arises for a circuit model and an electromagnetic field simulation.
Therefore, it is necessary to ask for external Q correctly by a simulation.
External Q is computable from conductance Gin near a resonance point and susceptance parameter b which were obtained from the simulation. When the shape of an antenna is small, conductance Gin uses the following methods, in order to compute external Q more correctly, since it becomes a very small value.

When external Q of a resonance device is set to Qe, input admittance Zin is expressed with a formula (74).
Therefore, the value of |Zin|2 becomes like a formula (75).
If the value of |zin|2 sets frequency used as one half of the values in center frequency to omega1 and omega2, external Q can be found from a formula (76).
What is necessary is just to design so that this external Q may fill a formula (38).

### Equation 32

FIG. 11 is a figure showing the simulation result of the value of external Q when changing antenna width W noting that antenna length L obtained from the above method is constant at 1000 [mum] or 1500 [mum] and characteristic impedance Z1 of CPW is 50 [omega].
A horizontal axis is antenna width and a vertical axis is external Q. If the width of an antenna is expanded, in order that radiation resistance may go up, the value of external Q becomes small.

Then, the design of a matching circuit is explained.
It designs using the antenna of length 1500 [mum] and width 600 [mum] as number of section n=1, reflection coefficient RLr=3 dB, and w=4.0% of a ratio band.
At this time, a standardization device value is calculated with g0=g2=1 and g1=2.0049 from formula (5)-(7).
When characteristic impedance of CPW is set to 29.9 [omega] and the length or LCPW is 3140 [mum], conductance Gin is 0.000441 [s], susceptance parameter b, 0.0221 and external Q is 50.06 by the culcuration at the center frequency of parallel resonance.

If a formula (39) is used, the designed value of J parameter will be acquired from conductance Gin.
Although J inverter is designed with the aforementioned design method, since the inverter of a first stage does not have a transmission line in the input side, it is necessary to perform adjustment of J parameter and resonance device length.
J inverter is attached to a parallel resonant circuit, and the length of a transmission line is adjusted so that series resonance may be obtained, when it sees from the outside.
What is necessary is just to make it the reactance component of input impedance Zin2 set to 0 with center frequency.
Gap length G of J inverter is adjusted so that Zin2 may become equal to Z0 (=50 [omega]).
As a result, it asked with electric length theta=2925 [mum] and gap length G=315 [mum].

Although a minute antenna with a matching circuit can be designed as mentioned above, since the whole length becomes long while the transmission line has been a straight line, a miniaturization cannot be attained.
Then, a transmission line is bent and it is made meander shape. Since the susceptance parameter of a resonant circuit will change if a transmission line is made into meander shape, J parameter of an inverter changes a little.
Therefore, resonance length and the gap length of J inverter are adjusted as similarly as the point.
As a result, gap length G was called for with G=290 [mum].

FIG. 12 compares with the conventional design method the design method which had described the size of the antenna so far.
As shown in FIG. 12(a), substrate thickness h is 0.5 [mm] and the same thing whose substrate material is MgO (specific-inductive-capacity epsilonr=9.6) was used for the substrate.
L and antenna width presuppose that the distance by W and a feeding point is antenna length Lf.
FIG. 12(b) is a figure showing the infinitesimal dipole antenna having element n=1, based on the design method described. The character of the antenna is: center frequency f0=5.0 GHz, reflection coefficient RLr=3 dB, and a ratio w=4.0% of a band.
The length of the antenna L is 1.5 [mm] (the whole 3.0 [mm]) and width W of the antenna is 0.6 [mm].
FIG. 12(c) is a figure showing an one-wave length slot antenna. Antenna length L is 14.1 [mm] (the whole 28.2 [mm]), and antenna width is 1.0 [mm].
FIG. 12(d) shows a patch antenna.
Both antenna length L and antenna width W are 9.7 [mm].
Bt the comparison of antenna area of a conventinal antenna with an antenna by this invention, that is about 1/16 of an one-wave slot antenna, and about 1/52 of a patch antenna, and that show a large miniaturization is realized.
It depends for the size of a communication circuit on the size of an antenna greatly.
It is thought by this design method that the miniaturization of the whole communication circuit can be attained.

FIG. 13 is a figure showing the appearance and the size of the minute slot antenna with a matching circuit designed with this design method. The antenna of FIG. 13 is designed have the following characteristics. The center frequency f0=5.0 GHz, a reflection coefficient RLr=3 dB and a ratio band w=4.0% and number of element n=1.

FIG. 14 is a figure showing the analysis output by the designed simulation about the reflection coefficient and transmission coefficient of an antenna.
A horizontal axis expresses frequency and a vertical axis shows a reflection coefficient and a transmission coefficient.
However, in order to perform a simulation in one port, only a reflection coefficient is obtained as analysis output.
The transmission coefficient of FIG. 14, a conductor loss is considered to be 0 and it is computed from the following formulas.

S11|2+|S21| It is computed from 2=1
The simulation result is mostly in accord as compared with a designed value.
Input impedance is set to 50.2 [omega] in center frequency to radiation resistance Ra=0.837 [omega].
Matching was able to be taken also when the rate of impedance conversion was very large.

The characteristics as a magnetic current dipole that the designed antenna is the same about directivity were acquired.
The magnetic current is also flowing through the slot on either side in the same direction, and is considered to operate as a magnetic current dipole.

In the design method described until now, although the design etc. are performed as number of element n=1, even if a number of element is two or more, designing similarly is possible.

An impedance-matching circuit can be designed also about the antenna called parallel dissonance like in-series dissonance.
Below, the outline is explained.

FIG. 15 is a figure showing other examples of antenna section 3 of FIG. 1.
As for the antenna of FIG. 15, an equal circuit is expressed with the parallel circuit of internal conductance Ga and internal capacitance Ca.
This antenna has an open point and it is parallel dissonance.

FIG. 16(a) is a figure showing the circuit which connected K inverter to the antenna equal circuit with a matching circuit.
In FIG. 16(a), electric length presupposes that characteristic impedance is a matching circuit a unlost transmission line of Z1 in theta.
At this time, input inductance Yin seen from terminal e-e′ becomes like a formula (78).
However, internal inductance Ya is Ya=Ga+jomegaCa.
And electric length theta fills the relation of a formula (47) to omega, L, C, and 1.
When resonance electric length is set to theta 0, input impedance Zin seen from terminal e-e′ can be expressed like a formula (78).
Here, Rin is internal resistance and x is a reactance slope parameter.

### Equation 33

In FIG. 16 (a), in view of terminal f-f′, K inverter is inserted in a resonant circuit and this input inductance Yin2 is expressed with a formula (79).

### Equation 34

On the other hand, FIG. 16(b) is a figure showing the circuit which used the filter.
The designed value of this filter becomes like a formula (80).
However, g is a standardization device value which can be found by a formula (5).

### Equation 35

In this circuit, when left-hand side is seen from terminal e-e′, input impedance Zin′ is expressed like a formula (81).
Therefore, input inductance Yin2′ which saw left-hand side from terminal f-f′ is expressed by the formula (82).

### Equation 36

What is necessary is just to ask for external Q of resonance, and K parameter of K inverter in a formula (79) and a formula (82), so that it may become Yin2=Yin2′.
Therefore, a designed value is given by the formula (83) and a formula (84).

### Equation 37

Then, the circuit which saw the left becomes equivalent to a resonator from terminal e-e′ of FIG. 16, and characteristics inductance Y1 and electric length theta 0 of the transmission line that the external Q fills a formula (83) are derived.

In a formula (77), when g and b are defined like a formula (85), electric length theta 0 will fill a formula (86) by deriving like a formula (42). Input reactance Xin and internal resistance Rin are expressed like a formula (87) by calculating like a formula (45) and a formula (46). Reactance slope parameter x is expressed as a formula (88) by calculating like a formula (49).

### Equation 38

External Q, a formula (89) is materialized by deriving like a formula (51).

### Equation 39

By allying a formula (89) and a formula (88), the design formula of Y1 and theta0 is obtained.
Here, since g<<1, b is realized with a minute antenna, a formula (88) and a formula (89) become like a formula (90) and a formula (91), respectively.

### Equation 40

A formula (92) will be drawn if a formula (90) and a formula (91) are arranged using a formula (85).

However, Ba is internal susceptance.

### Equation 41

The design formula of a matching circuit is given by a formula (92) as mentioned above.

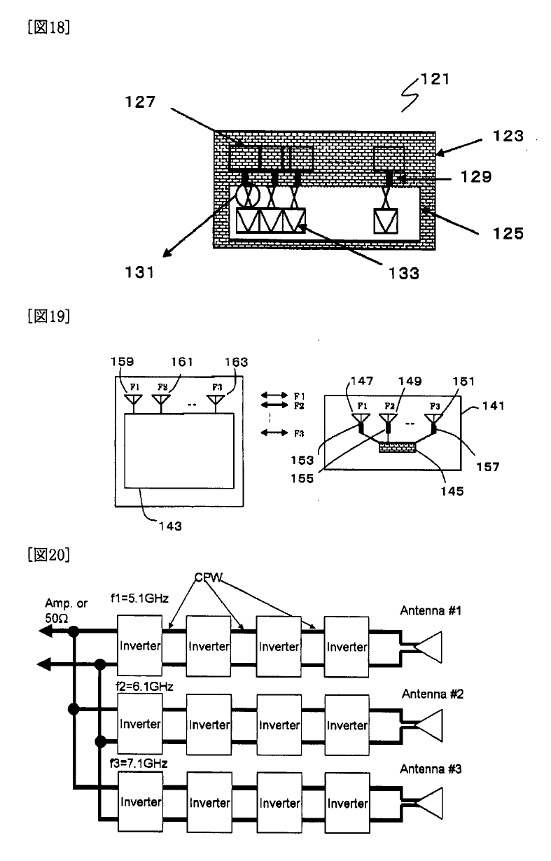

There is application to MIMO (Multi Input Multi Output) communication Technology as an embodiment of this invention, for example.
FIG. 17 is a figure showing communication circuit 101 which used MIMO communication Technology.
Communication circuit 101 is provided with semiconductor part 105 which is a part on substrate 103 and this substrate 103.
In this example, substrates 103 is high dielectric ceramics and semiconductor part 105 is SiGe.
In order to realize MIMO communication Technology, two or more miniaturized antennas of the same frequency arrange, and are formed. In FIG. 17, on substrate 103, two or more antennas 107 and matching circuits 109 arrange, and are provided.
Multi-antenna control circuit 111, LNA113 and PA115, mixer 117, and mixer 119 are formed in semiconductor part 105.
Multi-antenna control circuit 111 controls an antenna based on the MIMO_ANT control signal (ON and output) given from the exterior. LNA113 and PA115 output a 1st_IF signal via mixer 117 and mixer 119, respectively (Fi-Fo).
Each, Dwn.Con.OSC (Fo) and Up.Con.OSC (Fo) which are given from the exterior are inputted, and mixer 117 and mixer 119 operate.
Since an antenna can be miniaturized according to this invention, as compared with the antenna of other methods, two or more antennas can be easily constituted in narrow area in the same frequency.
Plural antenna equipment on radio equipment and a card with built-in apparatus is attained by this, and the correspondence to next-generation high-speed wireless data transmission is attained.

As other embodiments of this invention, there is application to UWB (Ultra Wideband) method communication, for example.
It is impossible to cover a wide band (3 GHz-7 GHz) with a single antenna. Therefore, it is necessary to put in order two or more antennas with which corresponding wavelengths differ, and to carry out band securing, and such communication is UWB method communication.
FIG. 18 is a figure showing communication circuit 121 which performs UWB method communication.
Communication circuit 121 is provided with semiconductor part 125 provided in substrate 123 and its part.
On substrate 123, two or more antennas 127 and CPW filters 129 arrange, and are provided.
Two or more CPW131 and stagger amplifier 133 with CPW are formed in semiconductor part 125 corresponding to antenna 127 and CPW filter 129. Communication circuit 121 covers the wide band with two or more miniaturized antennas 127 connected with device 125 with CPW filter 129 and an impedance-matching function.
Communication circuit 121 communicates a UWB method with a small multi-antenna combining two or more amplifier constituted on semiconductor 125 which performed phase control in digital one and suppressed troubles, such as an oscillation by the difference in a phase.

As other embodiments of this application, there is application to RFID or a noncontact IC card.
Since it depends for the size of the whole device on the size of an antenna greatly, this invention which can attain the miniaturization of an antenna suits these devices.
This invention can miniaturize the whole device further by using CPW+meander structure.
Also at this point, this invention suits these devices.

As other embodiments of this application, plural miniaturized antennas may perform the simultaneous transmissive communication in a wave number two or more rounds.
For example, it is simultaneous both directions.
For example, it is transmitting information which is mutually different in one way using plural frequency etc.
FIG. 19 is a figure showing an example of the simultaneous transmissive communication in plural frequency.
Terminals 141, such as a card, perform the simultaneous transmissive communication in main part system 143 and plural frequency.
Corresponding to semiconductor part 145 which processes, and plural frequency, plural antennas 147, 149, and 151, CPW153, and 155 and 157 are provided in terminal 141.
Corresponding to plural frequency, plural antennas 159, 161, and 163 are formed in a main part system.
It becomes possible to communicate simultaneously on plural frequency by realization of a miniaturized antenna, and plural matching (filter) depended on CPW.
Thereby, for example in RFID or a noncontact IC card, the number of times which carries out data authentication is reduced by communicating two or more times.
It enables safety to improve by distributed communication of a security code.

Center frequency can be provided with several mutually different matching circuits as other embodiments of this application, and it can be made to correspond to the frequency band which changes with these. A channel is made by this to correspond to each of a different frequency band, or there is a communication circuit which realized wide band-ization.

FIG. 20 is a circuit diagram showing the state of connecting each of three steps of band pass filter integral-type co-planer waveguide way (CPW) matching circuits to each of three antennas, and making three channels corresponding.

In FIG. 20, center frequency fl of the band pass filter to antenna #1 and a matching circuit is 5.1 GHz (100 MHz of bands).
Center frequency f2 of the band pass filter to antenna #2 and a matching circuit is 6.1 GHz (100 MHz of bands).
Center frequency f3 of the band pass filter to antenna #3 and a matching circuit is 7.1 GHz (100 MHz of bands).

FIG. 21 is a figure showing the result of having performed the simulation based on the circuit diagram of FIG. 20.
From this figure, it is clear that plural frequency bands which can be used for transmission and reception are obtained with the filter which the frequency band was distinguished without overlapping mutually and was set up in the communication device obtained from the circuit diagram of FIG. 20.
As the method of use of obtained plural frequency bands, the thing for transmission may be altogether used, the thing for reception may be altogether used, a part may be used for transmission and others may be used for reception.

FIG. 22 shows the circuit which connected each of three steps of band pass filter integral-type co-planer waveguide way (CPW) matching circuits to each of three antennas.
It is a circuit diagram showing the state where broadening of 5 GHz bands was attained by this.

In FIG. 22, center frequency fl of the band pass filter to antenna #1 and a matching circuit is 5.10 GHz (100 MHz of bands).
Center frequency f2 of the band pass filter to antenna #2 and a matching circuit is 5.44 GHz (100 MHz of bands).
Center frequency f3 of the band pass filter to antenna #3 and a matching circuit is 5.79 GHz (100 MHz of bands).

FIG. 23 is a figure showing the result of having performed the simulation based on the circuit diagram of FIG. 22.
It is clearer than this figure that the frequency band which can be used for transmission and reception of the bandwidth which amounts to 1 GHz with the filter which the frequency band overlapped and was set as the wide area in the communication device using the circuit of the circuit diagram of FIG. 22 is obtained.
As the method of use of the obtained frequency band, the thing for transmission may be altogether used and the thing for reception may be altogether used.

The form where plural matching circuits are made to constitute corresponding to plural antennas may be sufficient as the relation between plural matching circuits and an antenna.
As shown in FIG. 24, plural matching circuits may be connected to one antenna.
It may be a form which combines the above thing.

What is claimed is:

1. It is the communication circuit provided with the impedance-matching circuit linked to a nonresonant antenna and said nonresonant antenna,
The communication circuit as which said impedance-matching circuit has a transmission line which an end connects to said nonresonant antenna, and the electric length and characteristic impedance of said transmission line are determined by the predetermined approximate expression based on the frequency or the frequency band in which said nonresonant antenna and said transmission line resonate.

2. It is the communication circuit provided with the impedance-matching circuit linked to a nonresonant antenna and said nonresonant antenna.
Said impedance-matching circuit has a transmission line, and electric length theta 0 and characteristic impedance Z1 of said transmission line are external Q. Communication circuit computed by the formula (eq1) to reactance Xa and radiation resistance Ra of Qe1 and said nonresonant antenna.
[Equation 42]

3. It is the communication circuit provided with the impedance-matching circuit linked to a nonresonant antenna and said nonresonant antenna.
Said impedance-matching circuit has a transmission line, and electric length theta 0 and characteristics inductance Y1 of said transmission line are external Q. Communication circuit computed by the formula (eq2) to susceptance Ba and conductance Ga of Qe1 and said nonresonant antenna.
Equation 43]

4. The communication circuit according to claim 2 or 3 which has an electric power matching means to which said impedance-matching circuit adjusts said nonresonant antenna and the electric power of said transmission line, and the electric power of said external circuit.

5. Said electric power matching means is an inverter, and J parameter of said inverter is characteristic impedance Z0 and the communication circuit according to claim 4 as for which conductance Gin receives and which is computed by the formula (eq3) of said nonresonant antenna and said transmission line.
[Equation 44]

6. It is how to produce the impedance-matching circuit linked to a nonresonant antenna,
Said impedance-matching circuit has a transmission line which an end connects to said nonresonant antenna.
A method of producing an impedance-matching circuit that electric length and characteristic impedance of said transmission line contain a step determined by predetermined approximate expression based on frequency or a frequency band in which said nonresonant antenna and said transmission line resonate.

7. Impedance-matching circuit which is an impedance-matching circuit linked to a nonresonant antenna, has a transmission line, and is determined by the predetermined approximate expression based on a joint relation with the circuit excluding [the electric length and characteristic impedance of said transmission line ] said nonresonant antenna.

8. It is a communication device provided with two or more impedance-matching circuits according to claim 7,
The signal of frequency which the frequency band by at least two impedance-matching circuits where center frequency adjoins each other among said plural impedance-matching circuits is distinguished and set up, without overlapping mutually, and is mutually different to said matching circuit The input possibility of,
It is a communication device in which the input possibility of or said matching circuit to an output is possible to said matching circuit about the signal of frequency which the output possibility of or an input/output is possible, or overlaps, is set as a wide area and is mutually different from said matching circuit.

9. It is a designing method of an impedance-matching circuit linked to a nonresonant antenna,
An impedance-matching circuit design method containing a step which determines a circuit pattern of an impedance-matching circuit by a predetermined approximate expression based on a joint relation with an external circuit.
